(19) United States
(12) Patent Application Publication
(10) Pub. No.: US 2016/0122118 A1
(43) Pub. Date: May 5, 2016

(54) Preserved Microwavable Food Products

(71) Applicant: H. J. HEINZ COMPANY BRANDS LLC, Pittsburgh, PA (US)

(72) Inventors: Katherine Anne Smith, Pittsburgh, PA (US); Brian Huber, Pittsburgh, PA (US); Christopher P. Rowoth, Cranberry Township, PA (US); Beth A. Ritchey, Cranberry Township, PA (US); Brian Patrick Carman, Wexford, PA (US); Daniel C. Jackson, Wexford, PA (US); James Elwood Matthews, Wexford, PA (US)

(21) Appl. No.: 14/897,243

(22) PCT Filed: Jun. 6, 2014
(86) PCT No.: PCT/US14/41282

§ 371 Date: Dec. 10, 2015

Related U.S. Application Data
(60) Provisional application No. 61/833,268, filed on Jun. 10, 2013.

(51) Int. Cl. B65D 81/34; A23L 3/36; A23B 5/04

(52) U.S. Cl. CPC B65D 81/3453; A23L 1/32; A23B 5/043; A23L 3/364; A23L 1/0255; A23V 2002/00

(57) ABSTRACT

A microwavable tray containing a preserved, such as frozen, preferably liquid, food product. The tray can be capable of being folded at least in half and closed after microwaving. The liquid food product contained in the tray has the consistency and texture after microwaving of freshly prepared product, allowing it to be folded at least in half when the tray is folded, or even without a folding tray. During the microwave process, various fillings can be added to the product ether frozen or unfrozen prior to folding.

### CROSS-REFERENCE TO RELATED APPLICATIONS

This application claims the benefit of U.S. Provisional Patent Application Ser. No. 61/833,268 entitled “PRESERVED MICROWAVABLE FOOD PRODUCTS”, filed on Jun. 10, 2013, the disclosure of which is hereby incorporated by reference.

### TECHNICAL FIELD

The field of art to which this invention generally pertains is microwave packaging containing preserved food products.

### BACKGROUND

The attractiveness of on-hand, preserved food products is ever-increasing as daily schedules get more and more complicated. Coupled with fast and simple microwave processing, the combination of the two is becoming increasingly popular. That being said, people are still looking for products that resemble foods prepared “the old fashion way”, i.e., cooked in conventional fashion in an oven or on a stove-top. Certain types of foods present greater challenges than others in this regard. And liquid products, such as egg products, present especially challenging problems in this area.

The present invention meets the challenges described above, with additional benefits as described below.

### BRIEF SUMMARY

A sealed food package is described made up of a microwavable tray and a preserved microwavable food product contained in the tray, the preserved product after microwaving has the consistency and texture of a freshly prepared product.

Embodiments of the invention include: the tray capable of being folded at least in half after microwaving; the tray being capable of being closed after microwaving; the food product preserved by refrigeration or freezing; the food product being in liquid form prior to refrigeration or freezing; the tray having a substantially square shape; the tray having rounded corners and edges and an upwardly convex bottom; the food product containing protein, starch, leavening agent, and/or pectin; the product being a frozen egg product; the egg product additionally containing milk, cream, and/or water; the package additionally containing one or more sachets containing toppings for the product; at least one sachet containing cheese, meat, vegetable, condiment and/or mixtures thereof; the product, after microwaving, having substantially uniform texture, appearance and consistency; the tray being sealed with a lidding material; the lidding material being a lidding film, or a vacuum skin; and the lidding film containing a microwave steam release valve.

Other embodiments include: a method of making a microwavable, sealed, food product by placing a liquid food product in a microwavable tray, sealing the product in the tray with a lidding material, freezing the product either before or after sealing, the frozen product having the consistency and texture after microwaving of being folded at least in half when the tray is folded; the tray is capable of being folded at least in half and closed after microwaving; the lidding material being a lidding film, or a vacuum skin; the lidding film containing a microwave steam release valve; and the food product being capable of heat setting by coagulation, gelatinization, or leavening.

Other embodiments include: a method of making an egg product by placing a package comprising a microwavable tray containing a microwavable frozen egg product in a microwave oven, cooking the frozen egg product in the microwave oven, folding the cooked egg on itself, the egg product, after microwaving, having substantially uniform texture, appearance and consistency; the tray being capable of being folded at least in half and closed; at least one topping of cheese, meat, vegetable, condiment or mixtures thereof, being placed on top of the egg prior to folding; the tray having a substantially square shape, with rounded corners and edges, and an upwardly convex bottom; the egg additionally contains milk, cream, and/or water; and a food package made up of a microwavable tray and a preserved microwavable food product contained in the tray, the preserved product after microwaving having the consistency and texture of a freshly prepared product.

These, and additional embodiments, will be apparent from the following descriptions.

### BRIEF DESCRIPTION OF THE DRAWINGS

FIG. 1 shows one tray embodiment.

FIG. 2 shows another tray embodiment.

FIG. 3 shows one convex bottom embodiment.

FIG. 4 shows a folded tray embodiment.

FIG. 5 shows one sealed package embodiment.

FIG. 6 shows one cooked egg embodiment.

FIG. 7 shows one folded omelet embodiment.

FIG. 8 shows one sachet embodiment.

FIG. 9 shows one process flow chart embodiment.

FIG. 10 shows force data comparisons for some product embodiments

FIG. 11 shows pressure data comparisons for some product embodiments.

FIGS. 12 and 13 show a vacuum skin package embodiment.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

What is described generally herein is the cooking or baking of a liquid base food product which is preserved, e.g. by freezing, and is contained in a microwave-safe plate design. The combination of the liquid base food product and package design, among other things, results in even heating of the food while undergoing physical transformation during heat setting.

Generally, in order to prepare an omelet, it is necessary to purchase and prepare the eggs and toppings separately. If stove-top cooking methods are used, it is time consuming in both cooking and clean-up. And even if microwave cooking is used, the eggs must still be purchased and prepared separately before placement in the microwave for cooking. The methods and products described herein, use liquid, raw egg base products, typically preserved by freezing, and trays designed to be directly microwave cooked into an omelet. It should also be noted, that even if no toppings are applied to the egg product, many of the advantages of the present invention are still realized, such as ease of cooking and clean up; texture, consistency and appearance of the egg product, etc., as further described below. These advantages are realized by not only the egg (and other) liquid formulation, but the plate design as well. And the described consistency and texture results primarily from an evenness of heating across the sample. This can be demonstrated by bite force (Newtons) and IR (infrared) temperature analysis across an egg sample.

The folding feature of the microwavable plate is designed with an interlocking mechanism which offers advantageous consumer interaction with the packaging and product. The locked tray design (described further below) additionally offers, among other things, portability to the breakfast experience for the consumer as well.

In addition, when toppings, condiments or fillings are desired, sachets containing meats, cheeses, and/or vegetables, etc., or any combinations thereof, can be offered to provide a customized omelet of consumer choice. And of course, one always has the option of not using the frozen sachets included in the frozen package, and simply adding frozen or unfrozen available on-hand toppings of choice. The customization option with the inclusion of topping sachets clearly adds to the preparation enjoyment and eating experience (the sachets can also be provided separately in an unfrozen state).

Liquid food materials such as liquid protein, starch, leavening, and/or pectin containing materials can be used with the products and processes described herein. Starting with liquid food products, the food products undergo a transformation primarily by heat setting. With the use of one or more proteins, starches, leavening agents, pectin and/or mixtures of the same, individually or in various combinations, this transformation/heat setting can take the form of coagulation, gelatinization, etc. The liquid base food products undergo transformation during the cooking process via protein coagulation (e.g. egg), starch gelatinization and/or pectin thickening (e.g., puddings), and leavening (e.g., breads and batters). Pasteurized egg base is a particularly attractive starting point for the package, which is typically deposited into the microwave-safe plate design and frozen. The specific package design also contributes to the even heating of the food with superior product texture, appearance and consistency which the egg base formulation provides.

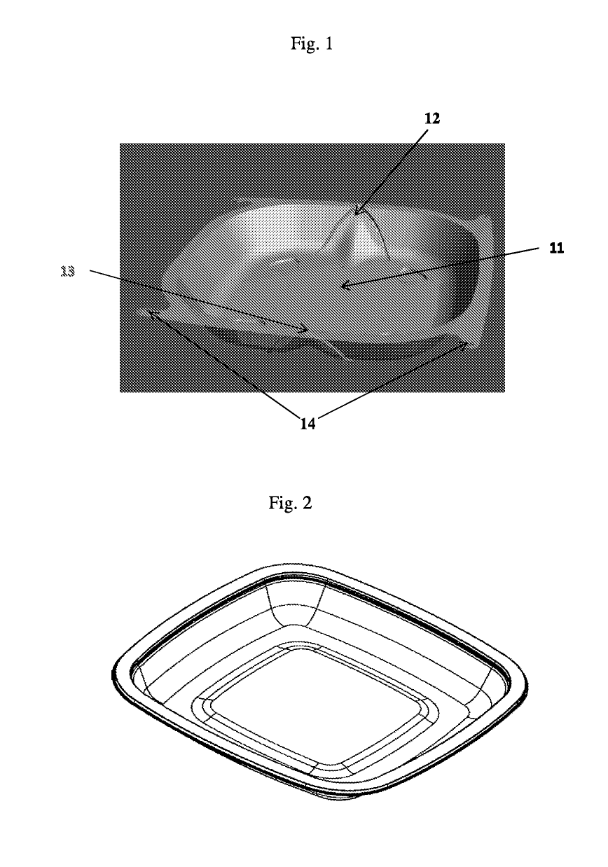

As shown in FIG. 1, the plate or tray design has a folding feature along the center axis (11) to allow the plate to be folded over on itself. The plate is typically made out of commercially available plastic material such as mineral filled polypropylene, polypropylene, CPET (crystalline polyethylene terephthalate), etc. There are two folding features in plate design, each folding feature on opposing sidewalls (12 and 13) of the plate. While the figure show an embodiment where the food product is folded in half, because of the improved consistency and texture of the food product described after microwaving, the product is also capable of being folded into thirds, quarters, etc. as desired (and of course, the food product can be folded at least in half, even without folding over the tray itself). Furthermore, because of the improved consistency and texture of the food products described herein after microwaving, even if a tray which does not fold is used with the present invention (see FIG. 2), the benefits of these properties can be realized by manually folding over the food product independent of a folding tray (as shown in FIG. 1).

Since evenness of cooking is an important part of the invention, a tray shape is used which contributes to this feature. Typically, prior to folding, the inside of the tray has an octagonal shape, with the outside of the overall tray being generally square with rounded corners. This shape has been found to contribute to the evenness of cooking required for the kind of premium product (e.g., texture, appearance, and consistency) intended to be offered. Another embodiment which contributes to the evenness of cooking of the product, is an upwardly convex bottom in the tray. The microwave upwardly convex bottom has a domed central portion and a lower, outer edge and the food product located at the lower, outer edge is thicker than the food product located at the domed central portion. See commonly assigned U.S. patent application Ser. No. 13/863,653, filed Apr. 16, 2013, and U.S. Pat. No. 7,878,356, the disclosures of which are herein incorporated by reference. It should also be noted that any shape tray which can be folded and can produce the consistency and texture required for folding, can be used, e.g., rectangular, elliptical, circular, octagonal, hexagonal, triangular, etc.

As also mentioned above, the unique folding feature of the tray allows various fillings to be cooked into the liquid product. For example, after partially microwave cooking an egg product for an initial period of time to allow the egg product to be folded, e.g. about 3 minutes, one or more fillings can be added to the eggs, such as bacon, ham, cheese, a variety of vegetables, etc., and mixtures of such ingredients, and the product returned to the microwave for additional cooking, e.g., about an additional minute. This can additionally cook the fillings into the egg, additionally cook the egg, and in the case of frozen fillings, defrost the fillings as well.

In one embodiment of the invention, the tray also has a locking mechanism (14 in FIG. 1) which insures the tray stays folded after cooking, with or without additional filling, but in addition, can provide portability of the tray for the user. In the particular embodiment shown in FIG. 1, two interlocking tabs (14) are shown for this purpose, however, other tray securing/closing options can be used as well. A version of this locking mechanism (41) can be seen in use in FIG. 4 which shows a tray locked after folding.

The egg product is cooked into an omelet product with texture, appearance and consistency similar to that found in conventional stove-top omelets. The texture and consistency of the cooked egg allows it to be able to fold over in the plate design. The interaction of the folding feature allows consumer to fold the egg product together to form a classic style omelet.

As mentioned above, evenness of heating in the microwave is an important factor to obtain the texture, appearance and consistency of a premium egg product. However, the specific composition of the egg products is also an important consideration in this regard. Liquid, pasteurized, whole eggs can be used as well as in-shell eggs. Egg whites can also be used, as well as combinations of whole eggs (shell eggs) and egg whites. Various combinations of protein from the eggs, and fat content, e.g., from dairy, are used to contribute to the texture and consistency desired. For example, various combinations of milk products, half-milk and half-cream products, cream products, water, egg base, combinations of whole egg and egg whites, etc. can be used (e.g., by weight, 80% to 99% liquid egg, 0% to 20% milk, and 0% to 5% hydrocolloids—optional for thickening/stabilizing).

While texture and consistency are an important part of the egg products described herein, this can vary over a wide range, e.g., fluffy or crepe style, to increasingly dense products. Because of the desirability of providing a product to which various fillings can be added during the cooking process, it is important that the texture and consistency be such that the product is able to be folded or flipped over on itself during the cooking process. So the at least partially cooked egg product must be of a texture and consistency to be able to hold together to flip over on itself, i.e., turn over without breaking apart, but also of a texture and consistency to allow it to be folded over simply by folding the package, i.e., not so dense or thick so as to not be able to folded when cooked as described herein—in other words, foldable without breaking apart, but foldable under the conditions described. For example, before cooking, the density of the egg formula is about 0.98 g/ml. The thickness of the uncooked raw liquid egg on the outside is about 0.338 inch and 0.238 inch in the center part of the tray.

Other considerations for the egg product formulation, is that the egg product not shrink during the microwave cooking process. As stated above, the size and shape of the tray is an important consideration for texture and consistency and evenness of heating. If significant shrinkage occurs during the cooking process, this shape change could affect the consistency and texture of the final product. Also for consumer marketing purposes, it is important that the product not experience significant or noticeable shrinkage during cooking. So it is important that the egg formulation does not shrink, that it matches the size and shape of tray in appearance, and maintain that shape during cooking.

It is also noteworthy that even regular eggs shrink after cooking when they're cooling, i.e., fluff out in microwave, then shrink when they come out of microwave and cool down. But the formulations described herein, in order to maintain their texture and consistency during the microwaving process, actually maintain their shape during cooling as well. As stated above, this significant shrinkage control is obtained by balancing, among other things, the moisture content, fat content, and protein content of the pre-cooked and post-cooked formulation. In addition to texture and consistency, the present formulation provides freshness in appearance, freshness in color, color uniformity and freshness in flavor and taste. Substantially uniform texture (and density) throughout the product is clearly obtained. And as described above, the cooked product is typically fluffy, and firm, and not spongy or rubbery.

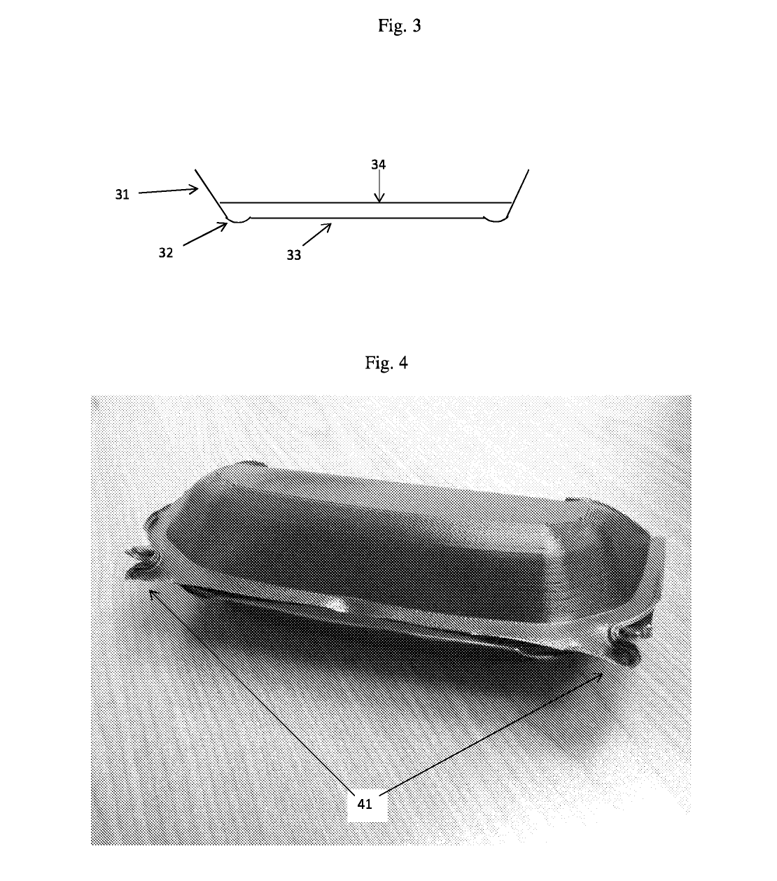

One form of convex bottom design which is helpful for attaining the evenness of heating described herein, is shown in FIG. 3. In this example, the side wall (31) and bottom (33) are supported by legs (32) which raise the bottom off of the microwave surface resulting in more even heating in the compartment containing the liquid food product (34). While the height of the dome is varied depending on the amount of liquid food product contained in the tray, i.e., to help produce the evenness of heating required, in this particular instance, the height of the dome of the tray shown is typically no greater than approximately 0.200 inch, and as shown here approximately 0.100 inch.

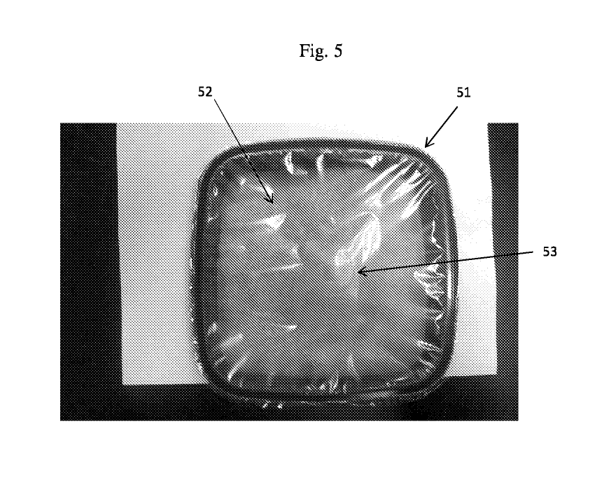

One form of sealed package design is shown in FIG. 5. In this example, the egg product contained in the tray (51) is sealed with lidding film (52). The film contains a conventional microwave steam release valve (53). The microwave steam valve on the lidding film helps cook the liquid egg in the microwave. The microwave steam valve helps the liquid egg in the microwave by controlling the pressure inside the package and helping to prevent tray deformation during cooking. Without a microwave steam valve, the pressure build up inside the tray cavity could become too great resulting in deformation of the tray and the shape of the egg base while microwaving, additionally resulting in uneven cooking.

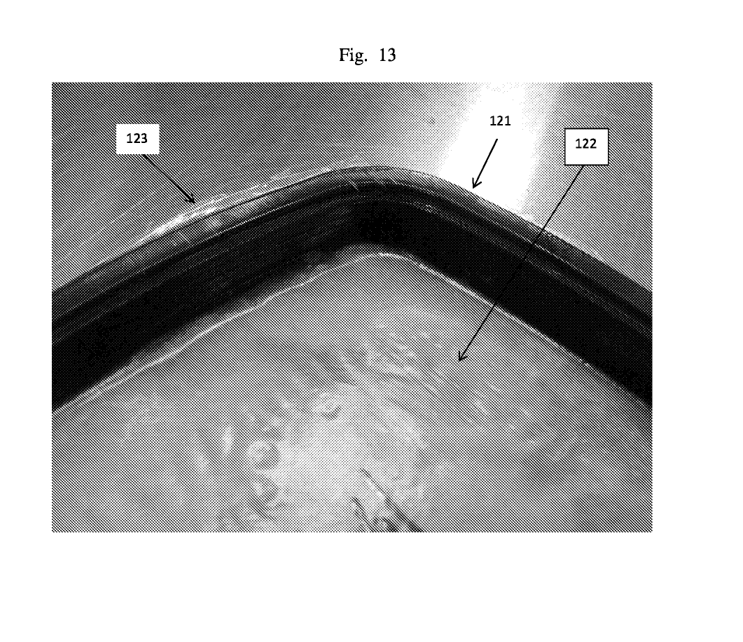

Another option for enclosing the liquid food product in the tray is the use of a vacuum skin packaging material, as shown, for example in FIGS. 12 and 13. An embodiment of this option is shown with the non-folding tray (121) in FIG. 12, although it can be used with the folding tray as well. The plastic material can be made of any of the polymers described herein. The frozen egg food product (122) is contained in tray and vacuum skin shown as indicated (123) (the black marker number on the tray is a sample number indicator).

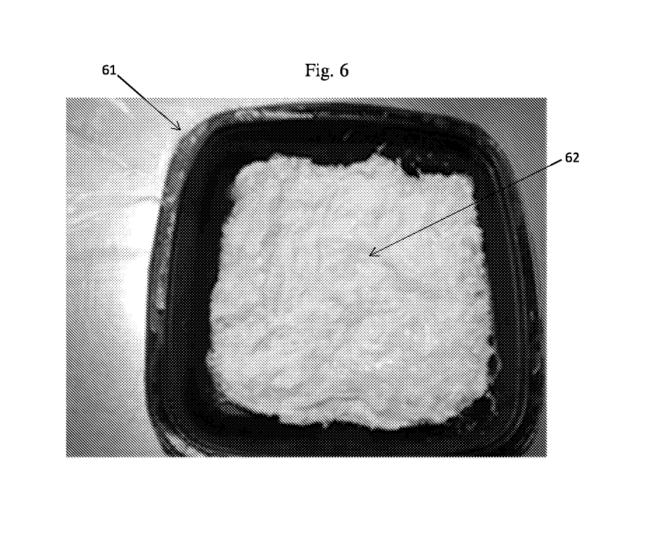

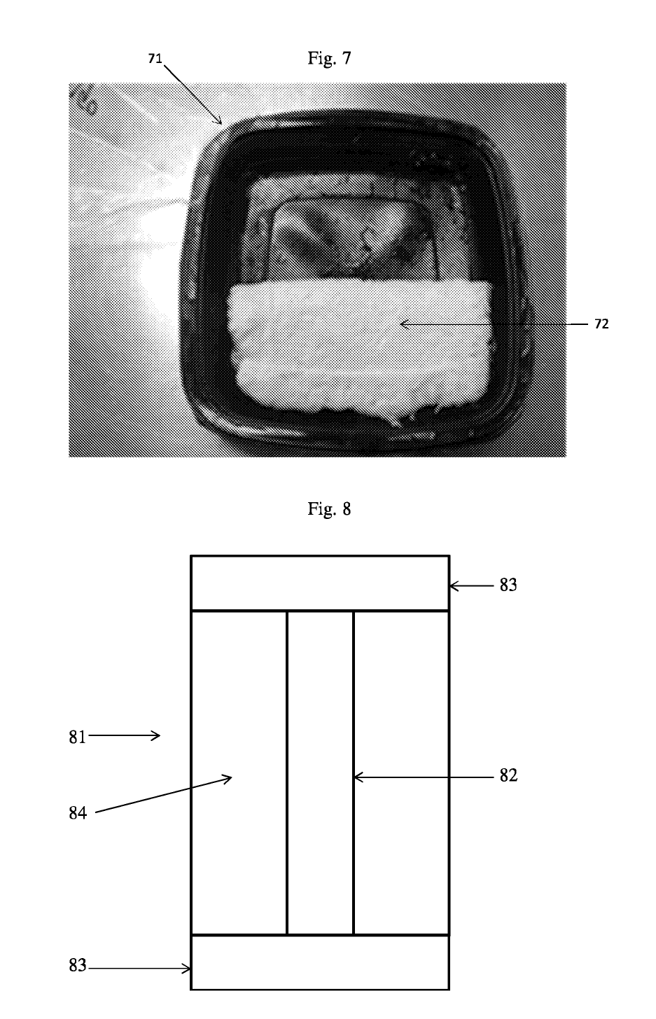

After removal of the film (FIG. 6), the microwave cooked egg product (62) is ready for consumption, or various toppings and condiments can be added and the egg (62, and 72 in FIG. 7) folded over to produce a folded egg product (72). In the case of the folded tray option, the tray can be folded over to fold the egg, and closed, and optionally locked, for easy transport of the cooked product as well. See FIG. 4.

While fillings, condiments or toppings which can be added to the egg before folding can be of any type desired by the ultimate user of the product, they are typically also frozen, and included with the egg package, in small packages, bags or sachets (as shown, for example, in FIG. 8). The sachets are typically relatively small, conventional plastic (e.g., polyethylene, polypropylene, polyester, etc.) bags (81) sealed across the middle (82) and at both ends (83), containing the frozen fillings within the bags (84). While the topping packet can be of any size or shape, they are typically square or rectangular, and range in size from about two to about five inches long, and about two to about five inches wide, depending on what ingredients are desired to be placed into the sachet.

The sachets can include any single ingredient, or combinations, of meat, cheese, and/or vegetable, e.g., one or more of cheese, cheese and bacon, diced tomatoes, bacon and cheese, feta cheese, broccoli, chicken, sausage, etc. In addition, they can include things you would not ordinarily have on-hand in your home or refrigerator, such as sun-dried tomatoes, goat cheese, Italian cheeses, capicola or other aged Italian meats, etc. Also available would be pre-mixed combinations of the fillings. Again, with simplicity, convenience, minimal clean-up and ease of use the goal, the fillings could be present in the package in pre-chopped portions for ease of use—no chopping, no pan, no cleaning, etc. The sachets, in addition to containing cheese, meat and/or vegetable, etc. or mixtures thereof, can also include condiments such as ketchup, hot sauce, salsa, sour cream, guacamole, etc., which can be included fresh, frozen, unfrozen, or otherwise preserved.

As stated above, while the user of the product can put on any toppings of choice themselves, the sachet-containing fillings can be put on the egg either in the frozen or unfrozen state, prior to the first microwave heating cycle, and allowed to sink into the egg as it defrosts and partially cooks in the first stage of microwave heating. The toppings can also be put on at the end of a first heating stage, and the egg product heated again, preferably with the lidding material still in place over the tray to heat and/or defrosted toppings prior to folding of the egg. The toppings can also be added at the end of the heating cycles, e.g., cheese, and the egg then folded over.

If the topping is added, additional microwave cooking is typically performed, e.g., to cook the added fillings into the folded egg product, or if frozen, to defrost and heat up the fillings, in addition to complete the cooking of the partially cooked egg product. In all instances, a product similar to the folded, stove-top prepared eggs, is delivered, minus the chopping, pan preparing and cleaning, stove-top cleaning, etc. associated with stove-top preparation.

The sachets can be made of materials similar to the trays, can be included with the frozen egg trays as purchased, or can be provided as separate frozen (or unfrozen) additions, and are similar to sachets offered in the past for other frozen food, non-egg products, such as T.G.I. Friday's® Nacho Toppers and Smart Ones® Pancakes, for example.

Typically, one egg weighs about 50 grams (gms). Typically, depending on the filling contained, each sachet will weigh about 15 gms to about 40 gms. So the egg packages will contain about 50 gms times the desired number of eggs in the package, e.g., 1 to 6 eggs weighing 50 to 300 gms, with a total egg weight of about 140 gms to about 160 gms being preferred. Similarly, assuming one sachet filling for each egg, the frozen package could contain about 15 gms to about 240 gms of sachet fillings.

The egg formulations are typically deposited into the tray, e.g., using a conventional volumetric filler, and frozen in conventional manner, e.g., using a conventional spiral freezer, although they can be pre-frozen and deposited into the tray after freezing. Similarly, the toppings are typically placed into the sachets and the package containing the toppings similarly frozen, although the toppings can also be included with the liquid egg and frozen at the same time as well.

After placement into the tray, a layer of plastic (e.g., conventional plastic used for this purpose, such as polyethylene, polypropylene, polyester, etc. as previously described) is bonded (by heat or conventional adhesive) to the top of the tray, either prior to or after freezing the egg product as described above, and as is typically done with other conventional frozen food products. However, optionally, the cover layer can be conventionally vacuum (or steam) sealed to the frozen egg product to help the product to retain moisture etc. which further contributes to the texture, appearance and consistency of the final product.

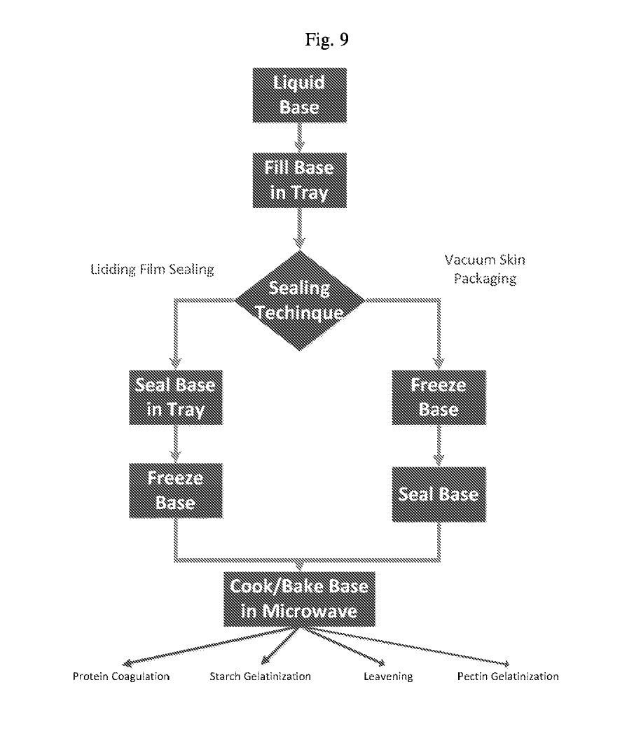

As shown in FIG. 9, in a typical process, the liquid food product is filled into the tray. The tray is then sealed, for example, using conventional lidding film sealing or vacuum skin packaging methods. In the case of lidding film sealing, the food product is typically first sealed in the tray, and then the food product is frozen.

In the case of vacuum skin packaging, the food product is typically frozen in the tray first, and then sealed in the package. This vacuum skin packaging helps to hold the frozen base in a uniform shape within a plate design to prevent deformation of the product during temperature fluctuations in transit. Traditional retail store environments can be subject to multiple freeze thaw cycles. Uneven cooking can occur when the frozen base thaws and re-freezes in non-uniform shapes. The vacuum skin packaging is found to hold the frozen base in place and therefore enable this product to be sold through the retail channel.

Vacuum skin packaging can also provide a steaming environment during product transformation. When testing the vacuum skin packaging on egg product, it was found that spraying a release agent on the top base surface prevents the product from sticking to the lidding film. Furthermore, by raising or lowering the sealing temperature, the bond strength between the film and the package increases or decreases respectively, allowing the package to vent in more or less time during cooking to improve cooking performance of the product.

The frozen egg package, as well as the frozen sachet fillings and toppings, are designed to be cooked in any conventional, e.g., 700 to 1200 watt microwave oven, typically 1100 watts for most conventional microwave ovens. As described above, this results in protein coagulation or starch gelatinization or pectin thickening.

### Example 1

Approximately 150 gms of raw egg mixed with whole milk, cream and water is placed in a tray shaped mold, heat set at 100° F. to 200° F., and frozen. The tray can have an internal octagonal shaped (as shown in the FIG. 1) or substantially square shape (as shown in FIG. 2), and the egg has a thickness of approximately 0.338 inch at the side portions of the tray, and approximately 0.238 inch in the middle portion of the tray. The density of the uncooked liquid egg is approximately 0.98 gms/ml (milliliter). The tray is sealed with a typical thin tray seal/cover of polyester, polypropylene or polyethylene. A sachet (as shown in FIG. 6) is filled with goat cheese and dried tomato. The filled sachet, weighing approximately 15 to 40 gms, is similarly frozen. The egg containing tray is placed in a conventional 1100 watt microwave and is cooked for approximately 3 minutes at full power. The thin seal/cover is removed, the frozen contents of the sachet material distributed evenly on the partially cooked egg product, and the egg is cooked for about an additional 1 minute, again at full power in the microwave. The tray is removed from the microwave and cooked egg is folded in half (either by folding the tray as in the case of FIG. 1, or just folding the egg as in the case of FIG. 2), resulting in a folded, filled, cooked egg product having the texture, appearance and consistency of a stove-top cooked product.

### Example 2

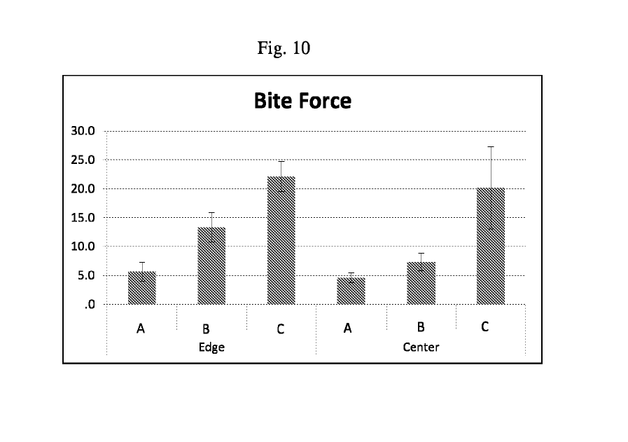

A texture analysis was performed on a liquid egg composition cooked once in a skillet, a liquid egg composition as described herein cooked in a microwave, and a conventional previously cooked and frozen egg composition cooked in a skillet. All omelet samples were left open, not folded, for the analyses. All omelet samples were cooked to a temperature above 165° F. and texture analysis was conducted while the omelet was at a temperature of 100° F. to 178° F. to try to simulate a “first-bite” analysis. Surface temperature data was confirmed via IR imaging. Two areas on the omelet were analyzed: the center and the edge of the unfolded omelet. The table below gives the raw data with standard deviation for each sample. The graph shown in FIG. 10, demonstrates the average Newtonian force (N) required to break the surface tension of the omelet, in an attempt to simulate a “first-bite” that a consumer would take, i.e., how much effort would be required to bite into the cooked omelet. While the graph and table demonstrate that the skillet omelet (A) is the softest, it also shows that the omelet described herein (B) demonstrates significant improvement over a conventional frozen omelet cooked in a skillet (C), including in the area of edge hardness.

| | Force (N) | | | | | |
|---|---|---|---|---|---|---|
| Location | Edge | | | Center | | |
| Sample | A | B | C | A | B | C |
| | 8.051 | 15.152 | 17.607 | 6.084 | 5.803 | 31.860 |
| | 4.790 | 11.146 | 23.737 | 4.163 | 9.676 | 17.045 |
| | 5.179 | 18.352 | 18.357 | 4.183 | 6.408 | 15.256 |
| | 4.522 | 9.210 | 24.252 | 4.955 | 7.861 | 14.639 |
| | | 14.708 | 25.490 | 4.108 | 6.890 | 21.988 |
| | | 12.984 | 22.785 | 4.007 | | |
| | | 11.709 | 22.533 | | | |
| | | 12.237 | 22.521 | | | |
| | | 14.217 | 20.020 | | | |
| | | 13.384 | 23.729 | | | |
| Average | 5.636 | 13.310 | 22.103 | 4.583 | 7.327 | 20.158 |
| Std Dev | 1.632972 | 2.514547 | 2.599399 | 0.810622 | 1.513301 | 7.149534 |

### Example 3

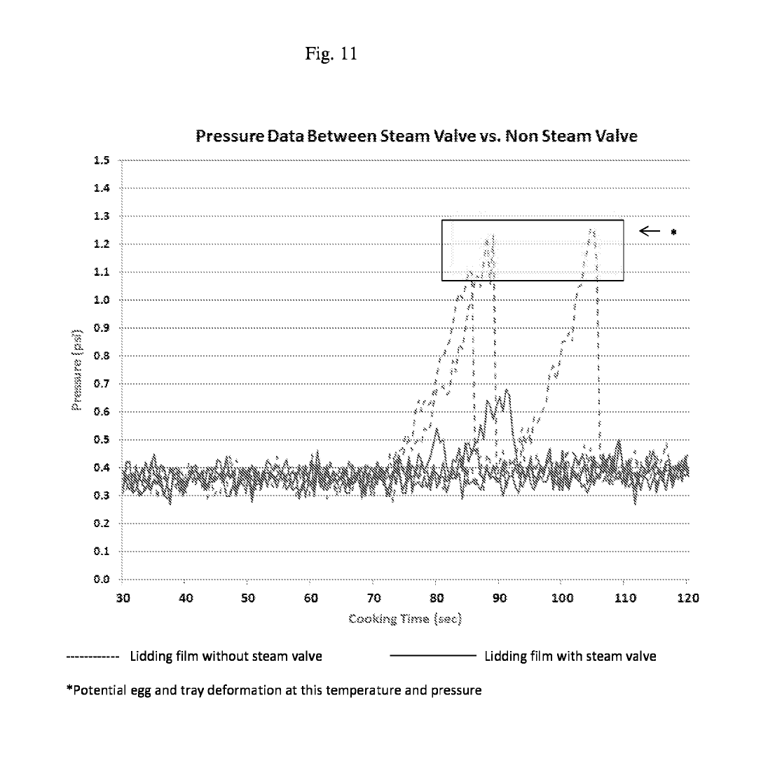

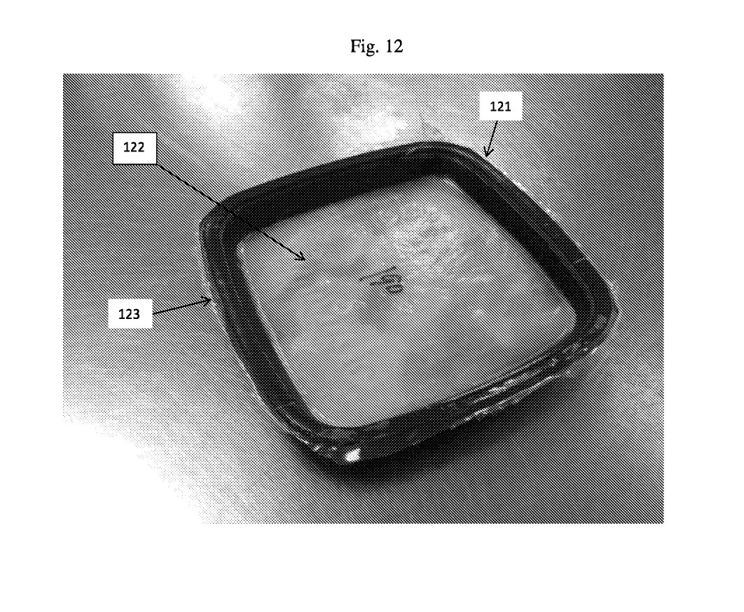

An embodiment of the package described herein with plastic lid film (without the fold feature in this test) was tested with and without a conventional microwave steam valve. The benefit of the microwave steam valve is that it controls the internal pressure of the tray during cooking which results in heating the egg at a more consistent rate in all locations of the tray thus resulting in more consistent texture and temperature in the final cooked product. Pressure testing during microwave cooking shows that the steam valve releases the pressure (steam) inside the package to prevent tray deformation and provide more even heating of the egg. The graph in FIG. 11 demonstrates the pressure differences between the trays with and without the steam valve.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A sealed food package comprising,
a microwavable tray having an upwardly convex lower surface including a domed central portion surrounded by a lower outer edge,
a food product within the tray, at least a portion of the food product being a liquid room temperature, and
a lidding material sealing the food product within the tray,
wherein the domed central portion is configured to establish a food product having a central portion that is thinner than an outer portion so that central portion and the outer portion results in even heating during microwave cooking.

2. The package of claim 1, wherein the food product comprises an egg product.

3. The package of claim 2, wherein the egg product has a thickness over the domed central portion of the tray that is about 0.1 inches less than a thickness over the lower outer edge of the tray.

4. The package of claim 3, wherein the egg product wherein the egg product has a thickness of about 0.238 inches over the domed central portion of the tray and a thickness of about 0.338 inches over the lower outer edge of the tray.

5. The package of claim 1, wherein the egg product has a density of about 0.98 g/ml.

6. The package of claim 1, wherein the food product comprises about 80% to about 99% liquid egg product, about 0 to about 20% milk product, and about 0 to about 5% hydrocolloids.

7. The package of claim 1, further comprising at least one sachet comprising toppings for the product, wherein at least one sachet contains at least one of a cheese, a meat, a vegetable, and a condiment.

8. The package of claim 1, wherein the food product contains protein, starch, leavening agent, and/or pectin.

9. The package of claim 1, wherein the domed central portion has a height of less than about 0.2 inches.

10. The package of claim 9, wherein the domed central portion has a height of about 0.1 inch.

11. The package of claim 1, wherein the tray has an octagonal shape.

12. The package of claim 11, wherein the octagonal shape comprises a generally square outer perimeter with rounded corners.

13. The package of claim 1, further comprising a folding feature a long a center axis of the tray, wherein the folding feature comprises two folding segments on opposing sidewalls of the tray wherein the product, after microwaving, has substantially uniform texture, appearance and consistency.

14. The package of claim 13, wherein the tray further comprises an interlocking mechanism configured to hold the tray in a folded position.

15. The package of claim 1, wherein the lidding material comprises at least one of a lidding film or a vacuum skin.

16. The package of claim 1, wherein the lidding material comprises a microwave steam release valve.

17. A method of making a microwavable sealed food product comprising,
placing a liquid food product in a microwavable tray, the tray having an upwardly convex lower surface including a domed central portion surrounded by a lower outer edge, the domed central portion establishing a food product having a thinner central portion and a thicker outer portion,
sealing the food product in the tray with a lidding material, and
freezing the food product,
wherein the freezing occurs either before, during, or after the sealing.

18-21. (canceled)

22. A method of making an omelet comprising,
placing a food package in a microwave oven, the food package comprising:
a microwavable tray with an upwardly convex lower surface, the upwardly convex lower surface including a domed central portion surrounded by a lower outer edge,
a frozen egg product within the tray, the frozen egg product arranged to form a central portion that is thinner than an outer portion, the central portion being positioned over the domed central portion of the microwavable tray, and
a lidding material sealing the food product within the tray,
heating the food package in the microwave oven for a first predetermined time period to form an at least partially cooked egg product,
applying contents of a sachet to the at least partially cooked egg product,
folding the package to fold the at least partially cooked egg product on itself, and
heating the food package in a microwave for a second predetermined time period to establish a cooked omelet.

23. The method of claim 22, wherein the first and second heating steps combine to cook the omelet to a temperature above 165° F.

24. The method of claim 22, wherein the average force to break the surface tension of the cooked omelet at the center of the omelet is less than about 9 Newtons.

25-27. (canceled)
